(19) United States
(12) Patent Application Publication
(10) Pub. No.: US 2008/0124603 A1
(43) Pub. Date: May 29, 2008

(54) Mixed reactants and electrolyte fuel cell

(76) Inventor: Jiahua Han, Vernon Hills, IL (US)

Correspondence Address: Jiahua Han, 845 Westmoreland Dr. Apt 6, Vernon Hills, IL, 60061, US

(21) Appl. No.: 11/986,488

(22) Filed: Jan. 3, 2008

Related U.S. Application Data
(60) Provisional application No. 60/861,211, filed on Nov. 27, 2006.

(51) Int. Cl. H01M 8/10; H01M 4/96; H01M 4/90; H01M 4/92; H01M 8/12; H01M 8/14

(52) U.S. Cl. 429/30; 429/33; 429/44; 429/46

(57) ABSTRACT

The working principle of this invention is that the electrolyte can reach any sites that the reactants can reach, thus the working ions produced from the reactants' reactions on the catalyst sites can be transported immediately inside the electrolyte; it could further increase the number of possible reactions sites of a fuel cell, the catalyst structure are not limited the be attached at the electrolyte structure surface, but any location the said mixture of reactants and electrolyte is able to reach, including the surface of said flow channels etc. All the catalyst structures where the same or similar kind of electro-chemical reaction occurring are connected electronically for form one electrode of said mixed reactants and electrolyte fuel cell.

### CROSS REFERENCE TO RELATED APPLICATIONS

This patent filing claims the benefit of earlier filed provisional applications: Application No. 60/861,211, filing date Nov. 27, 2006, Confirmation No. 3828, filing receipt *OC000000021502680*, Title, Mixed reactants and electrolyte fuel cell.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING

Not applicable.

### COMPACT DISC APPENDIX

Not applicable.

### BACKGROUND OF THE INVENTION

Fuel cell is regarded as a energy transfer device for the future with less pollution and high efficiency. However, so far, the power density, the reactants crossover, the cell working temperature etc many effectors affect the performance of a fuel cell, this invention is proposed as another possible solution to solve these problems and increase the cell performance and durability.

### BRIEF SUMMARY OF THE INVENTION

This invention is to introduce a new kind of fuel cell. Mixed reactants and electrolyte fuel cell could be any kind of fuel cell that is able to transfer the reactant's chemical energy into the electrical energy. Because the electrolyte is mixed with the reactants and supplied to the catalysts sites where the reactions occur, this way will simplify the structure the a fuel cell, increase the power density, lower the reactants crossover of the electrolyte membrane and increase the cell working temperature etc.

### BRIEF DESCRIPTION OF THE SEVERAL VIEWS OF THE DRAWING

Not applicable.

### DETAILED DESCRIPTION OF THE INVENTION

What is claimed is mixed reactants and electrolyte fuel cell, said mixed reactants and electrolyte fuel cell could be any type of electro-chemical devices that is able to convert the reactants' chemical energy directly into electrical energy; the working principle of this invention is that the electrolyte can reach any sites that the reactants can reach, thus the working ions produced from the reactants' reactions on the catalyst sites can be transported immediately inside the electrolyte; it could further increase the number of possible reactions sites of a fuel cell, the catalyst structure are not limited the be attached at the electrolyte structure surface, but any location the said mixture of reactants and electrolyte is able to reach, including the surface of said flow channels etc. All the catalyst structures where the same or similar kind of electro-chemical reaction occurring are connected electronically for form one electrode of said mixed reactants and electrolyte fuel cell; as an example, for the direct methanol or direct formic acid fuel cell, the fuel, methanol or formic acid can be mixed with certain kinds of acid and then be supplied to the catalyst layer. This way, a thinner electrolyte polymer, thinner catalyst layer on polymer could be used to lower the mass transport losses inside the catalyst layer and the catalyst layer could also be attached to the flow channel surface, increasing the total reaction surface and the power density; For a mixed reactants fuel cell, if the selectable catalysts are used as the catalysts for the fuel cell, it is possible even to eliminate the electrolyte polymer like Nafion® etc. The selectable catalysts can just be attached at the surface of an acid-resistant electronic conductive sheet; this sheet could be metal sheet or other kinds of thin sheet, then the methanol crossover will be totally eliminated and the cell can run under higher temperature than a normal Nafion® etc electrolyte membrane can stand, the deterioration problem of the MEA should also be improved to some extent; said electrolyte work as an ion transport media during the energy transfer process; one kind of the reactants or all kinds of the reactant are mixed with a kind of electrolyte or a combination of several kinds of electrolyte and is supplied to said mixed reactants and electrolyte fuel cell.

1. some similar parts as usual fuel cells like two electrode structure, one is anode electrode and the other is cathode electrode, there are catalyst structures attached or integrated to the electrodes to accelerate the electro-chemical reactions processes occurring at the anode side and the cathode side of said mixed reactants and electrolyte fuel cell; electrolyte structures, which are conductors for certain kind of working ions, such as H⁺, OH⁻, CO₃²⁻, O²⁻ etc, said electrolyte structure could be liquid or liquid absorbed porous structure or even in solid form at some situations, such as electrolyte polymer like Nafion® etc; said working ions are the mobile ions which are the products of the reactions occurring at the cathode (or anode) electrode of said mixed reactants and electrolyte fuel cell and are one kind of the reactants for the reactions occurring at the opposite electrode reaction sites, for proton exchange membrane fuel cell, including direct methanol fuel cell, direct formic acid fuel cell, hydrogen PEMFC etc, said working ion is proton; for molten carbonate fuel cell, said working ion is CO₃²⁻, for solid oxide fuel cell, said working ion is O²⁻; catalyst structure, catalyst structure are comprised of catalyst, depending on working conditions, electrolyte and other electronic conductor such as carbon, graphite, certain kind of metal or metal alloy etc are optionally included; there is a catalyst structure on the cathode side and there is a catalyst structure on the anode side of said mixed reactants and electrolyte fuel cell; said catalyst structures on both anode and cathode sides could be the same or different from each other; said catalyst includes one type of metal, or a combination of several kinds of metals, or alloy comprising of metals chosen from the group of metals Pt, Ru, Pd, Ti, Zr, Hf, V, Nb, Ta, Cr, Mo, W, Au, Sc, Cr,Mn,Fe,Ni,Cu,Y,Tc,Rh,Cd,Lu,Ta,Re,Os and Ir; optionally it could also include any other kind of materials which is able to work as catalyst to accelerate the reactions occurring at the cathode side of said mixed reactants and electrolyte fuel cell catalyst layer or the reactions occurring at the anode side of said mixed reactants and electrolyte fuel cell or both.

2. Flow channels, flow channels are fabricated on the cell electrode plates or other cell components to supply the reactants to the catalyst reaction sites at the anode side or cathode side or both sides of said mixed reactants and electrolyte fuel cell; said flow channels could be in 2-D dimension form or in 3-D dimension form.

3. In said mixed reactants and electrolyte fuel cell, one or both types of reactants are mixed with liquid electrolyte or other types of solutions under working conditions, which is a conductor of said working ion, then the mixture is supplied through the flow channel to the catalyst reaction sites at the anode side or cathode side or both sides of said mixed reactants and electrolyte fuel cell.
